(19) United States
(12) Patent Application Publication
(10) Pub. No.: US 2014/0346005 A1
(43) Pub. Date: Nov. 27, 2014

(54) BALL AND RAMP DEVICE FOR A TOROIDAL VARIATOR

(71) Applicants: Patrice Ribault, Vouvray (FR); Yves-André Liverato, Saint Paterne Racan (FR)

(72) Inventors: Patrice Ribault, Vouvray (FR); Yves-André Liverato, Saint Paterne Racan (FR)

(21) Appl. No.: 14/354,060

(22) PCT Filed: Oct. 24, 2011
(86) PCT No.: PCT/EP11/68546

§ 371 Date: Aug. 8, 2014

(51) Int. Cl. F16D 13/46

(52) U.S. Cl. CPC F16D 13/46
USPC 192/93 A

(57) ABSTRACT

The ball and ramp device for a toroidal variator includes a first disc and a second disc and a plurality of rolling elements disposed between ramps provided on the discs and extending along the circumferential direction. One of the discs provides a plate having the ramps, a ring delimiting an outer toroidal raceway and an intermediate supporting part axially interposed between said ring and the plate.

The present invention relates to the field of ball and ramp devices for toroidal variators.

A toroidal variator may be used for instance in a supercharger for a combustion engine, in an air conditioning system, in an alternator, in a cooling fan or in a main power transmission of a motor vehicle.

A toroidal variator is generally provided with an input disc and an output disc facing each other and delimiting a toroidal cavity or space, and with a plurality of rollers positioned within the toroidal space and coming into engagement contact with raceways of the input and output discs to transfer a torque from one disc to the other. The rollers are arranged so as to be distributed over the circumference of the toroidal space and can be adjusted spatially within said space in order to adjust the transmission ratio of the variator continuously. Each roller of the toroidal variator is supported by a carriage connected to a control mechanism allowing said roller to be steered across the raceways of the discs.

The rotational speeds of the input and output discs determine the operating ratio of the variator, which ratio is by definition the input speed divided by the output speed. Each change of the rollers angular position results in a change of the variator ratio.

Patent application GB-A-2 438 412 (Torotrak) discloses a toroidal variator comprising an input disc, an output disc, rollers mounted rotatably between the input an output discs and coming into engagement with raceways provided on said discs, and a ball and ramp device to generate an axial force proportional to the torque applied to the input disc. Said device is formed by a plate, the rear face of the input disc and a set of balls axially interposed between ramps provided on said rear face and the plate.

The manufacture of the massive input disc is cost-intensive since the material used is high-strength steel. Besides, the forming of the toroidal raceway and the ramps on such a disc requires long machining operations.

One aim of the present invention is to overcome these drawbacks.

It is a particular object of the present invention to provide a ball and ramp device for a toroidal variator which is simple to manufacture and economic.

In one embodiment, the ball and ramp device for a toroidal variator comprises first and second discs, and a plurality of rolling elements disposed between ramps provided on the first and second discs and extending along the circumferential direction. One of said discs comprises a plate having the ramps, a ring delimiting an outer toroidal raceway and an intermediate supporting part axially interposed between said ring and the plate.

The plate may comprise a radial portion having the ramps. The intermediate supporting part may be axially disposed between the radial portion and the ring.

Preferably, the plate comprises an inner axial portion and an outer axial portion radially surrounding said inner axial portion. The intermediate supporting part may be radially located between the inner and outer axial portions of the plate. In one embodiment, said inner and outer axial portions extend from the radial portion.

In one embodiment, the plate further comprises outer axial lugs extending from the outer axial portion and located into recesses formed on the ring. Alternatively, the intermediate supporting part comprises outer axial lugs extending into recesses formed on the ring. Advantageously, the outer lugs may further extend into recesses formed on the plate.

The intermediate supporting part is advantageously made from thermoplastic. The supporting part may be overmoulded onto the plate and the ring.

Preferably, the other disc comprises a radial portion having the ramps and axially facing the radial portion of the plate. The ring may be made from a metal sheet. Further, the ring may have in cross-section a toroidal shape.

In one embodiment, the rolling elements comprise balls or rollers which may be tapered or not.

The present invention and its advantages will be better understood by studying the detailed description of specific embodiments given by way of non-limiting examples and illustrated by the appended drawings on which:

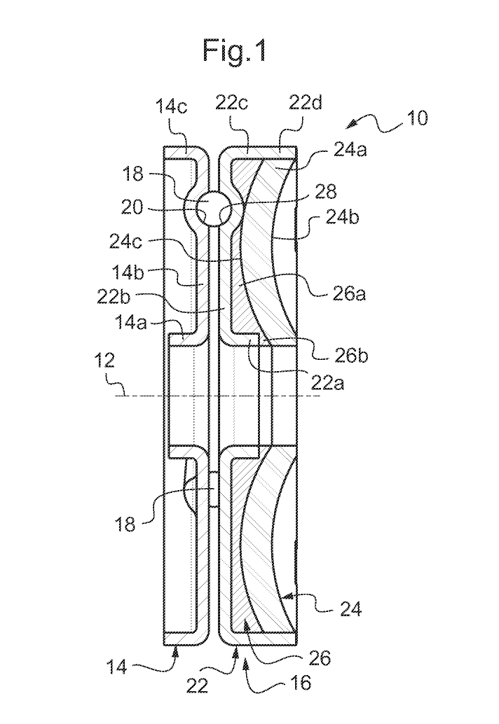

FIG. 1 is a section of a ball and ramp device for a toroidal variator according to a first embodiment of the invention,

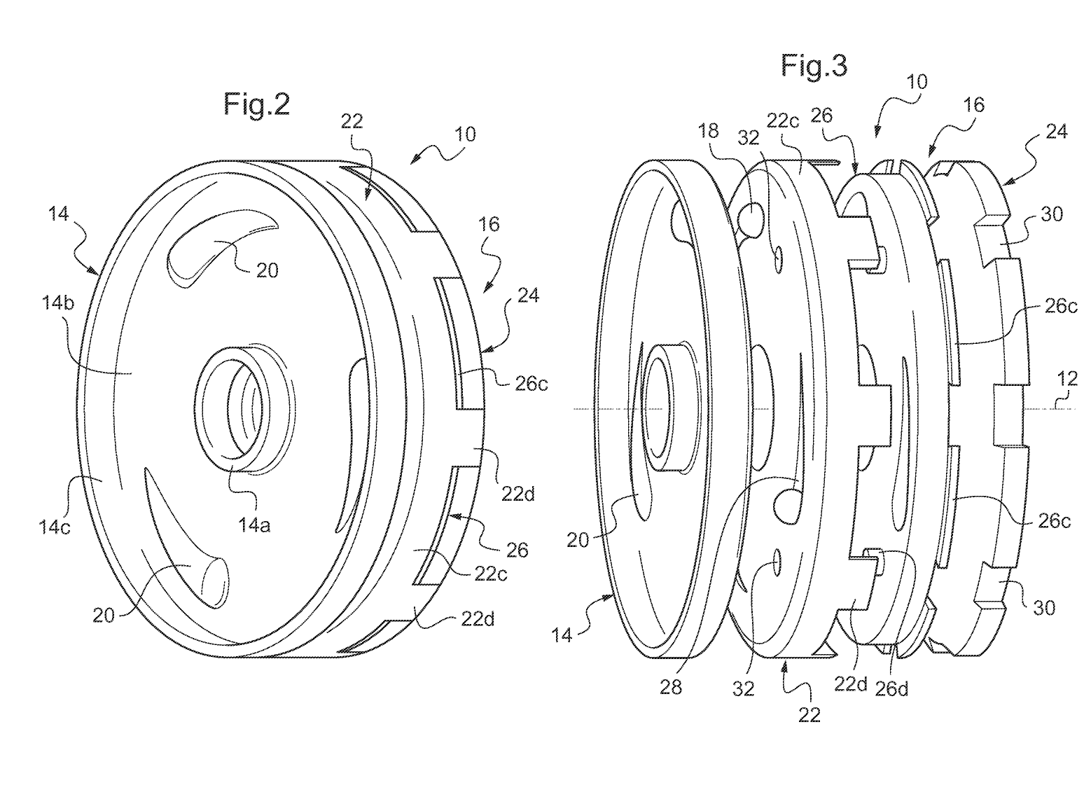

FIG. 2 is a perspective view of the device of FIG. 1,

FIG. 3 is an exploded perspective view of the device of FIG. 1,

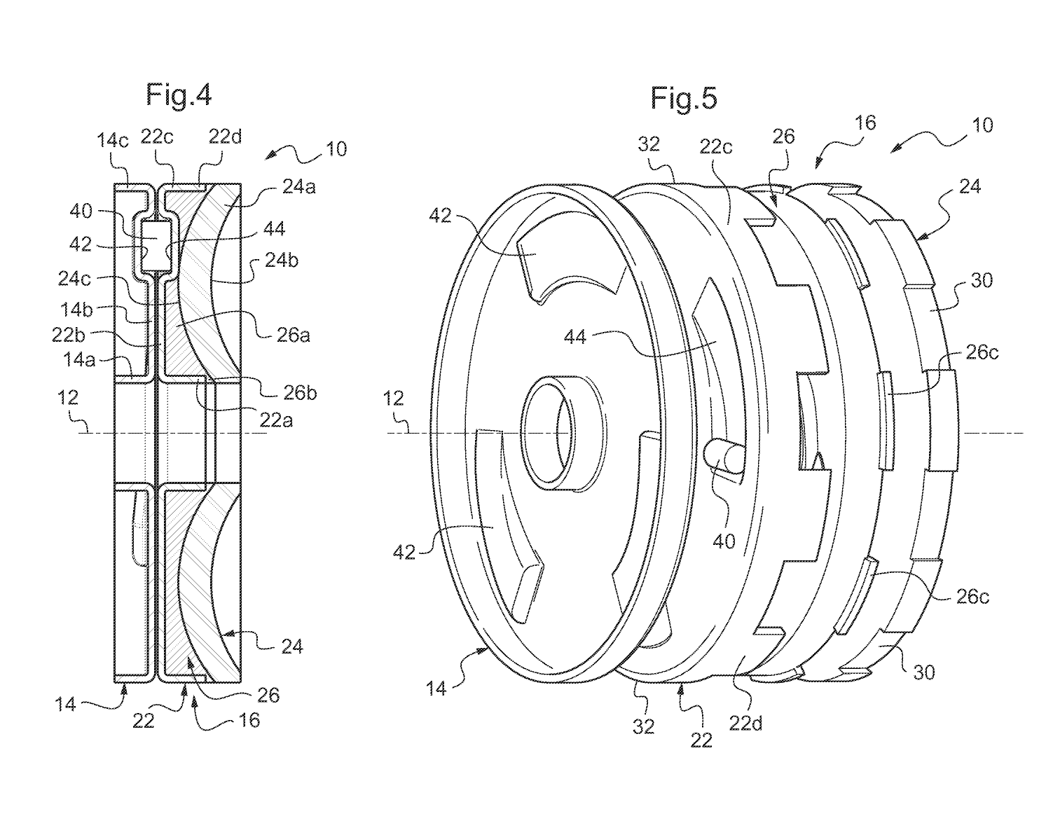

FIG. 4 is a section of a ball and ramp device for a toroidal variator according to a second embodiment of the invention,

FIG. 5 is an exploded perspective view of the device of FIG. 4,

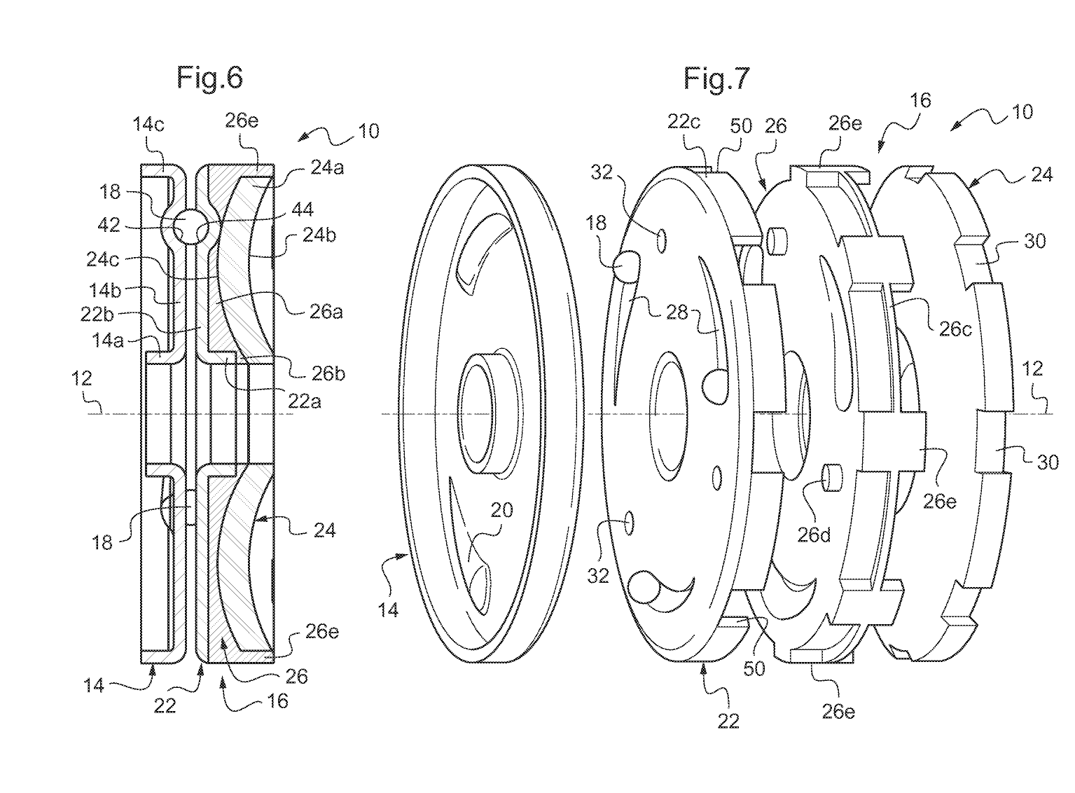

FIG. 6 is a section of a ball and ramp device for a toroidal variator according to a third embodiment of the invention, and

FIG. 7 is an exploded perspective view of the device of FIG. 6.

As illustrated on FIGS. 1 to 3, which illustrates an example of a ball and ramp device 10 for a toroidal variator according to the invention, said device 10, with an axis 12, comprises a first disc 14 and a second disc 16 axially facing each other, and a plurality of balls 18 axially disposed between said discs.

The first disc 14 is advantageously formed from a metal sheet by folding, cutting and stamping. The disc 14 is annular, coaxial with the axis 12 and comprises an inner axial portion 14a having an axial bore into which is mounted a shaft (not shown), a radial portion 14b extending radially outwards from the axial portion 14a, and an outer axial portion 14c extending axially from a large-diameter edge of the radial portion 14b and radially surrounding the inner axial portion 14a. The radial portion 14b comprises, on its internal front surface which axially faces the second disc 16, a plurality of recesses extending in the circumferential direction and forming ramps 20. The ramps 20 are obtained by local deformations of the radial portion 14b. In the illustrated embodiment, the ramps 20 are three in number and regularly spaced from one another in the circumferential direction. The ramps 20 are identical to one another and formed on the radial portion 14b, at a common radius with respect to the axis 12. The ramps 20 have in cross section a concave profile adapted to the balls 18 and forming a raceway for said balls. Each ramp 20 has a depth which gradually varies in the circumferential direction.

The second disc 16, coaxial with the axis 12, comprises a plate 22, a ring 24 and an intermediate supporting part 26 axially interposed therebetween. The plate 22 is advantageously formed from a metal sheet by folding, cutting and stamping. The plate 22 is annular and comprises an inner axial portion 22a having an axial bore of same diameter as the bore of the axial portion 14a of the disc. The plate 22 also comprises a radial portion 22b extending radially outwards from the axial portion 22a and an outer axial portion 22c extending axially from a large-diameter edge of the radial portion 22b and radially surrounding the inner axial portion 22a. The radial portion 22b axially faces the radial portion 14b of the disc 14. An axial gap is formed between said radial portions 14b, 22b. The axial portions 22a, 22c and the radial portion 22b of the plate are respectively symmetrical with the axial portions 14a, 14c and the radial portion 14b of the disc relative to a transverse radial plane passing through said axial gap.

The plate 22 further comprises a plurality of circumferential recesses forming ramps 28 provided on the internal front surface of the radial portion 22b facing the first disc 14. The ramps 20, 28 axially face each other in an inverted position. The plate 22 also comprises identical axial lugs 22d extending from the outer axial portion 22c axially on the opposite side of the disc 14. In the illustrated embodiment, the outer lugs 22d are eight in number and regularly spaced from one another in the circumferential direction.

In the disclosed embodiment, the ring 24 has in cross-section a toroidal shape. The ring 24 is annular and comprises a toroidal portion 24a having an axial bore of same diameter as the bore of the plate 22. The external front surface of the toroidal portion 24a delimits a concave toroidal raceway 24b adapted to be into contact with rollers (not shown) of the associated toroidal variator. Such rollers transmit drive between the toroidal raceway 24b and a facing toroidal raceway of the toroidal variator. The raceway 24b may be finished (for instance by grinding or hard turning) and superfinished (for instance by lapping or honing or vibrofinishing) in order to obtain its geometric characteristics and its definitive surface finish. The outer axial surface of the ring 24 comprises a plurality of recesses 30 regularly spaced from one another in the circumferential direction. Each lug 22d of the plate 22 axially extends into one of these recesses 30 of complementary shape. Collaboration between the lugs 22d and the recesses 30 provides an angular connection between the plate 22 and the ring 24.

The intermediate supporting part 26 is disposed axially between a convex internal surface 24c of the toroidal portion 24a of the ring which is axially opposite to the concave raceway 24b and the external front surface of the radial portion 22b of the plate. The supporting part 26 is in axial contact against the ring 24 on one side and in axial contact with the plate 22 on the other side. The supporting part 26 is disposed radially between the outer axial portion 22c and the bore of the inner axial portion 22a of the plate.

The supporting part 26 is annular and comprises a radial portion 26a having a concave external surface in axial contact with the convex surface 24c of the ring of complementary shape, and an opposite internal radial surface in axial contact with the radial portion 22b of the plate of complementary shape. The outer axial surface of the radial portion 26a is in radial contact with the outer axial portion 22c of the plate. The bore of said radial portion 26a recovers the inner axial portion 22a of the plate. The supporting part 26 also comprises an inner annular skirt 26b extending radially inwards an axial end of the bore of the radial portion 26a. The radial skirt 26b has a bore of same diameter as the bore of the plate 22 and is axially located between the inner axial portion 22a of said plate and the ring 24. The supporting part 26 further comprises a plurality of ribs 26c extending radially outwards the outer axial surface of the radial portion 26a and regularly spaced from one another in the circumferential direction. Each rib 26c is located axially between the outer axial portion 22c of the plate and the ring 24, and circumferentially between two successive lugs 22d of said plate. Each lug 22d extends axially across the space delimited between two successive ribs 26c.

The supporting part 26 also comprises axial pins 26d extending from the internal front surface of the radial portion 26a and protruding into corresponding holes 32 formed in the radial portion 22b of the plate. The supporting part 26 is made in one part by overmoulding a thermoplastic material, for instance such as a polyamide, onto the plate 22 and the ring 24. This results in an excellent cohesion between these parts, in particular at the holes 32 which the melted plastic material penetrates to form the pins 26d by matching shape. The production of the supporting part 26 by moulding makes it possible to give it shapes with a large degree of lightness and a low manufacturing cost. Alternatively, the supporting part 26 could however be made of another material, for instance metal, and/or be fixed onto the plate 22 and the ring 24 by any other appropriate means, for example by gluing.

The embodiment shown on FIGS. 4 and 5, in which identical parts are given identical references, differs from the previous embodiment in that a plurality of rollers 40 are axially disposed between the disc 14 and the plate 22. Associated ramps 42, 44 are respectively formed on the radial portion 14b of the disc and the radial portion 22b of the plate in a similar way to the ramps of the previous embodiment. The ramps 42, 44 each have in cross section a U-shaped profile adapted to the rollers 40 and form raceways for said rollers. In the illustrated embodiment, the rolling surfaces of the rollers 40 have a cylindrical profile. Alternatively, the rolling surfaces may have a tapered profile.

The embodiment shown on FIGS. 6 and 7, in which identical parts are given identical references, differs from the first embodiment in that the intermediate supporting part 26 comprises a plurality of outer axial lugs 26e extending axially the outer axial surface of the radial portion 26a on the opposite side of the disc 14, while being regularly spaced from one another in the circumferential direction. Each lug 26e extends axially from the internal front surface of the radial portion 26 and protrudes axially both into the space delimited between two successive ribs 26c and one recess 30 of the ring 24. Axially on the opposite side of the ring 24, each lug 26e is located into one of the recesses 50 of complementary shape formed on the radial portion 22c of the plate. With such an embodiment, a torque applied to the plate 22 is transmitted to the ring 24 by the lugs 26e of the supporting part 26.

In the disclosed embodiment, the rolling elements are balls.

Alternatively, the rolling elements may be cylindrical or taper rollers. In another variant, it could also be possible, for each disclosed embodiment, to foresee a cage axially disposed between the discs 14, 16 for maintaining the rolling elements circumferentially spaced apart.

The interposition of a supporting part axially between the plate having the ramps and the ring having the toroidal raceway permits to obtain a robust and low cost ball and ramp device adapted to a toroidal variator. With such a device having a disc made as an assembly of distinct components, the plate and the ring may be made from different metal, each selected in order to best address the mechanical requirements, and manufactured by using any forming process, for instance forging. For instance, the supporting part may be made from a lower quality material, for instance a thermoplastic such as PA6.6, whereas the ring is made from a bearing steel and the plate is made from a medium/high carbon steel, such as C55, or a construction steel such as E24.

1. A ball and ramp device for a toroidal variator comprising:
a first disc and
a second disc, and
a plurality of rolling elements disposed between ramps provided on the first and second discs and extending along the circumferential direction, wherein one of the discs includes a plate (22) having the ramps, a ring delimiting an outer toroidal raceway and an intermediate supporting part axially interposed between the ring and the plate.

2. The ball and ramp device according to claim 1, wherein the plate provides a radial portion having the ramps.

3. The ball and ramp device according to claim 2, wherein the intermediate supporting part is axially disposed between the radial portion and the ring.

4. The ball and ramp device according to any of the preceding claims, wherein the plate includes an inner axial portion and an outer axial portion radially surrounding the inner axial portion.

5. The ball and ramp device according to claim 4, wherein the intermediate supporting part is radially located between the inner and outer axial portions of the plate.

6. The ball and ramp device according to claim 5, wherein the plate further comprises outer axial lugs extending from the outer axial portion and located into recesses formed on the ring.

7. The ball and ramp device according to claim 5, wherein the intermediate supporting part includes outer axial lugs extending into recesses formed on the ring.

8. The ball and ramp device according to claim 7, wherein the outer lugs further extend into recesses formed on the plate.

9. The ball and ramp device according to claim 8, wherein the intermediate supporting part is made from thermoplastic.

10. The ball and ramp device according to claim 9, wherein the intermediate supporting part is overmoulded onto the plate and the ring.

11. The ball and ramp device according to claim 10, wherein the ring is made from a metal sheet.

12. The ball and ramp device according to claim 11, wherein the ring has in cross-section a toroidal shape.

13. The ball and ramp device according to claim 12, wherein the rolling elements comprise balls.

14. The ball and ramp device according to claim 12, wherein the rolling elements comprise rollers.

15. The ball and ramp device according to claim 14, further comprising taper rollers.
